(19) United States
(12) Patent Application Publication
(10) Pub. No.: US 2022/0397379 A1
(43) Pub. Date: Dec. 15, 2022

(54) Multi-Tool Assembly

(71) Applicant: Ory Hensley, Houston, TX (US)

(72) Inventor: Ory Hensley, Houston, TX (US)

(21) Appl. No.: 17/343,892

(22) Filed: Jun. 10, 2021

(51) Int. Cl. G01B 3/1089; G01B 3/1043; G01B 3/1046

(52) U.S. Cl. CPC G01B 3/1089; G01B 3/1043; G01B 3/1046

(57) ABSTRACT

A multi-tool assembly includes a first housing and a tape measure that is integrated into the first housing. The tape measure is drawable outwardly from the first housing to facilitate distance to be measured. A second housing is hingedly coupled to the first housing and the second housing is positionable in a deployed position and a folded position. A blade slide is slidably integrated into the second housing and the blade slide is urgeable between an extending position and a retracting position. A blade is insertable into the blade slide and the blade extends outwardly from the second housing when the blade slide is positioned in the extending position for cutting. The blade is retracted within the second housing when the blade slide is positioned in the retracting position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tool devices and more particularly pertains to a new tool device for facilitating measuring and cutting to be performed with a single tool. The device includes a first housing that is hingedly coupled to a second housing. A tape measure is positioned in the first housing and a utility knife is positioned in the second housing.

### (2) Description of Related Art including information disclosed under 37 CFR 1.97 and 1.98.

The prior art relates to tool devices including a variety of tape measure devices that each has tape measure and a knife for combining measuring distance and cutting. In each instance the tape measure and the knife are housing in a common housing. In no instance does the prior art disclose a multi-tool that includes a pair of housings that are hinged together, each of which containing a respective tape measure and a knife.

### BRIEF SUMMARY OF THE INVENTION

An embodiment of the disclosure meets the needs presented above by generally comprising a first housing. A tape measure is integrated into the first housing and the tape measure is drawable outwardly from the first housing to facilitate distance to be measured. A second housing is hingedly coupled to the first housing and the second housing is positionable in a deployed position and a folded position. A blade slide is slidably integrated into the second housing and the blade slide is urgeable between an extending position and a retracting position. A blade is insertable into the blade slide and the blade extends outwardly from the second housing when the blade slide is positioned in the extending position for cutting. The blade is retracted within the second housing when the blade slide is positioned in the retracting position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a multi-tool assembly according to an embodiment of the disclosure.

FIG. 2 is a bottom view of an embodiment of the disclosure.

FIG. 3 is a left side perspective view of an embodiment of the disclosure.

FIG. 4 is a right side phantom view of an embodiment of the disclosure.

FIG. 5 is a front view of an embodiment of the disclosure.

### DETAILED DESCRIPTION OF THE INVENTION

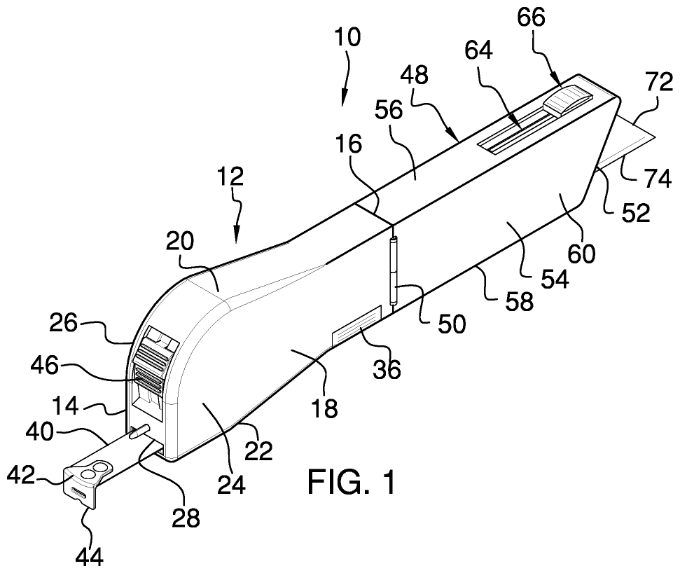

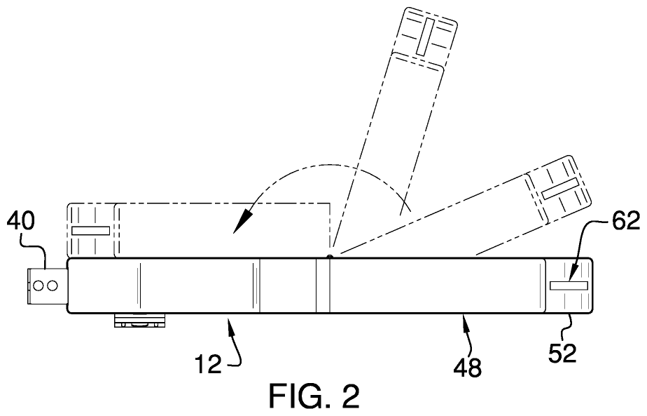

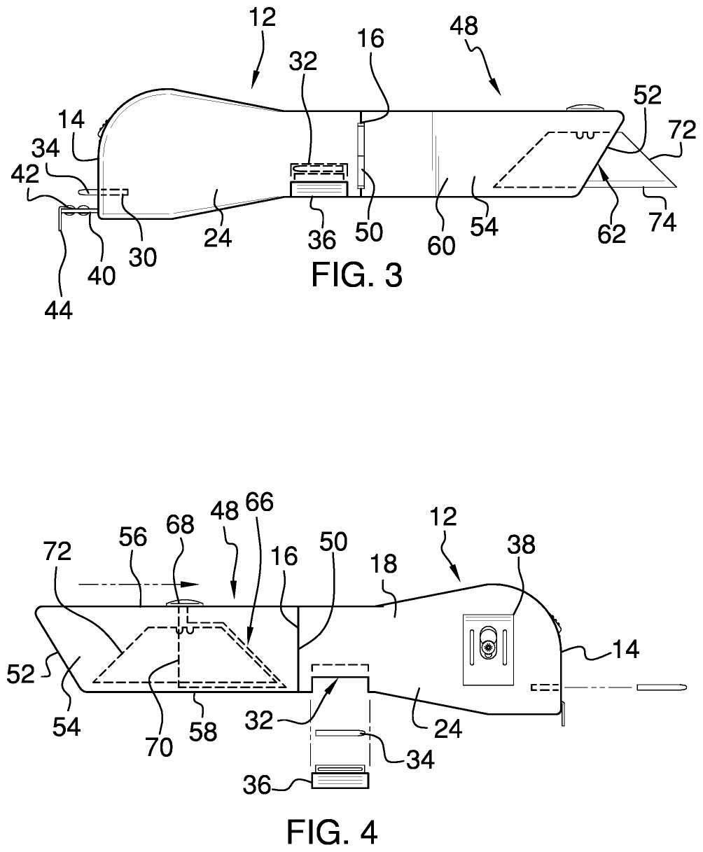

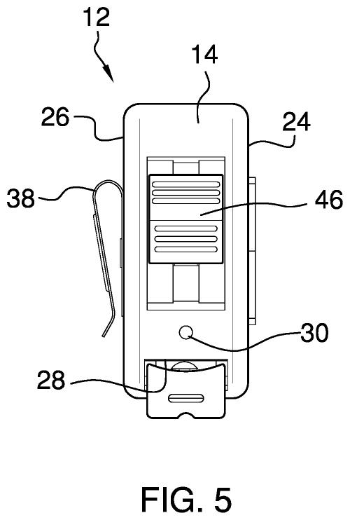

With reference now to the drawings, and in particular to FIGS. 1 through 5 thereof, a new tool device embodying the principles and concepts of an embodiment of the disclosure and generally designated by the reference numeral 10 will be described.

As best illustrated in FIGS. 1 through 5, the multi-tool assembly 10 generally comprises a first housing 12 has a first end 14, a second end 16 and an outer wall 18 extending therebetween, and the outer wall 18 has a top side 20, a bottom side 22, a first lateral side 24 and a second lateral side 26. The first end 14 has a slot 28 extending into an interior of the first housing 12 and the slot 28 is positioned adjacent to the bottom side 22 of the outer wall 18. The first end 14 has a well 30 extending therein and the well 30 is positioned above the slot 28. The outer wall 18 has a storage compartment 32 extending into an interior of the first housing 12 for storing a plurality of pencil leads 34. Moreover, a respective one of the pencil leads 34 is insertable into the well 30 to facilitate a user to make markings. The pencil leads 34 may comprise pencil leads commonly employed with mechanical pencils or the like. The top side 20 curves upwardly from the bottom side 22 at a point located adjacent to the first end 14, and the top side 20 is curved at an intersection between the top side 20 and the first end 14.

A cap 36 is removably attachable to the outer wall 18 of the first housing 12 for closing the storage compartment 32. A belt clip 38 is coupled to the first housing 12 to engage a belt worn by the user. The belt clip 38 is positioned on the outer wall 18 and the belt clip 38 is biased to compress against the outer wall 18.

A tape measure 40 is provided and the tape measure 40 is integrated into the first housing 12. The tape measure 40 is drawable outwardly from the first housing 12 to facilitate distance to be measured. The tape measure 40 is biased to be retracted into the first housing 12 for storage. Conversely, the tape measure 40 extends outwardly through the slot 28 when the tape measure 40 is drawn outwardly from the first housing 12. The tape measure 40 has a distal end 42 that is exposed with respect to the first end 14 of the first housing 12. The distal end 42 has a hook 44 coupled thereto to engage an object for securing the tape measure 40 to the object for measuring distance.

The tape measure 40 includes a lock 46 that is recessed into the first end 14 of the first housing 12. The lock 46 is positioned between the well 30 in the first end 14 and the top side 20 of the outer wall 18 of the first housing 12. Additionally, the lock 46 is movable between a locking position and a releasing position. The lock 46 engages the tape measure 40 when the lock 46 is positioned in the locking position for retaining the tape measure 40 at a selected length with respect to the first housing 12. The lock 46 disengages the tape measure 40 when the lock 46 is positioned in the releasing position thereby facilitating the tape measure 40 to move freely. The tape measure 40 may comprise a spring loaded tape measure of any conventional design and may have a length ranging between approximately 3.0 feet and 30.0 feet.

A second housing 48 is provided and the second housing 48 is hingedly coupled to the first housing 12. The second housing 48 is positionable in a deployed position having each of the first housing 12 and the second housing 48 extending along a common axis. The second housing 48 is positionable in a folded position having the second housing 48 lying against the first housing 12. The second housing 48 has a primary end 50, a secondary end 52 and an exterior wall 54 extending between the primary end 50 and the secondary end 52, and the exterior wall 54 has an upper side 56, a lower side 58 and a first lateral side 60.

The primary end 50 is hingedly coupled to the second end 16 of the first housing 12, and the primary end 50 abuts the second end 16 when the second housing 48 is positioned in the deployed position. The first lateral side 60 of the exterior wall 54 rests against the first lateral side 24 of the outer wall 18 of the first housing 12 when the second housing 48 is positioned in the folded position having the secondary end 52 being positioned adjacent to the first end 14 of the first housing 12. The secondary end 52 angles rearwardly between the upper side 56 and the lower side 58. The secondary end 52 has a blade slot 62 extending into an interior of the second housing 48, and the blade slot 62 extends substantially between the upper side 56 and the lower side 58 of the exterior wall 54. The upper side 56 of the exterior wall 54 has a channel 64 extending inwardly therein. The channel 64 is elongated to extend substantially between the secondary end 52 and the primary end 50, and the channel 64 is positioned closer to the secondary end 52 than the primary end 50.

A blade slide 66 is slidably integrated into the second housing 48 and the blade slide 66 is urgeable between an extending position and a retracting position. The blade slide 66 includes a button 68 that is positioned in the channel 64 in the upper side 56 of the exterior wall 54 of the second housing 48 such that the button 68 can be manipulated by a user. The blade slide 66 includes a frame 70 that is slidably positioned within the second housing 48. Moreover, the frame 70 is attached to the button 68 such that the frame 70 is slidable toward or away from the secondary end 52 of the second housing 48 when the button 68 is slid toward or away from the secondary end 52.

A blade 72 is insertable into the blade slide 66 and the blade 72 extends outwardly from the second housing 48 when the blade slide 66 is positioned in the extending position. In this way the blade 72 can be employed for cutting. The blade 72 is retracted within the second housing 48 when the blade slide 66 is positioned in the retracting position to inhibit the blade 72 from cutting. The blade 72 is positionable in the frame 70 of the blade slide 66. Moreover, the blade 72 extends outwardly through the blade slot 62 in the secondary end 52 of the second housing 48 when the blade slide 66 is positioned in the extending position. Moreover, a cutting edge 74 of the blade 72 is directed toward the lower side 58 of the exterior wall 54 of the second housing 48 when the blade slide 66 is in the extending position. The blade 72 may be a utility knife blade, a razor blade or any other type of disposable blade.

In use, the first housing 12 is gripped to facilitate the tape measure 40 to be employed for measuring distance. Additionally, a pencil lead 34 can be inserted into the well 30 to facilitate the pencil lead 34 to make markings during measuring, such as marking a line on a piece of lumber for cutting. The blade 72 can be extended for cutting and scoring purposes. Additionally, the second housing 48 can be positioned in the folded position to reduce the length of the first housing 12 and the second housing 48 for compact carrying.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. A multi-tool assembly including a utility knife and a tape measure, said assembly comprising:
a first housing;
a belt clip being coupled to said first housing wherein said belt clip is configured to engage a belt worn by the user;
a tape measure being integrated into said first housing, said tape measure being drawable outwardly from said first housing wherein said tape measure is configured to facilitate distance to be measured, said tape measure being biased to be retracted into said first housing for storage;
a second housing being hingedly coupled to said first housing, said second housing being positionable in a deployed position having each of said first housing and said second housing extending along a common axis, said second housing being positionable in a folded position having said second housing lying against said first housing;
a blade slide being slidably integrated into said second housing, said blade slide being urgeable between an extending position and a retracting position;
a blade being insertable into said blade slide, said blade extending outwardly from said second housing when said blade slide is positioned in said extending position wherein said blade is configured to be employed for cutting, said blade being retracted within said second housing when said blade slide is positioned in said retracting position wherein said blade is configured to be inhibited from cutting;
wherein said first housing has a first end, a second end and an outer wall extending therebetween, said outer wall having a top side, a bottom side, a first lateral side and a second lateral side;
wherein said first end has a slot extending into an interior of said first housing, said slot being positioned adjacent to said bottom side of said outer wall;
wherein said first end having a well extending therein, said well being positioned above said slot;
wherein said outer wall having a storage compartment extending into an interior of said first housing for storing a plurality of pencil leads, a respective one of said pencil leads being insertable into said well wherein said respective pencil lead in said well is configured to facilitate a user to make markings; and
wherein said top side curves upwardly from said bottom side at a point located adjacent to said first end, said top side being curved at an intersection between said top side and said first end.

3. The assembly according to claim 2, wherein said tape measure extends outwardly through said slot when said tape measure is drawn outwardly from said first housing, said tape measure having a distal end being exposed with respect to said first end of said first housing, said distal end having a hook being coupled thereto wherein said hook is configured to engage an edge for securing said tape measure to the edge for measuring distance.

4. The assembly according to claim 2, wherein said tape measure includes a lock being recessed into said first end of said first housing, said lock being positioned between said well in said first end and said top side of said outer wall of said first housing, said lock being movable between a locking position and a releasing position, said lock engaging said tape measure when said lock is positioned in said locking position for retaining said tape measure at a selected length with respect to said first housing, said lock disengaging said tape measure when said lock is positioned in said releasing position thereby facilitating said tape measure to move freely.

5. The assembly according to claim 2, wherein said second housing has a primary end, a secondary end and an exterior wall extending therebetween, said exterior wall having an upper side, a lower side and a first lateral side, said primary end being hingedly coupled to said second end of said first housing, said primary end abutting said second end when said second housing is positioned in said deployed position, said first lateral side of said exterior wall resting against said first lateral side of said outer wall of said first housing when said second housing is positioned in said folded position having said secondary end being positioned adjacent to said first end of said first housing, said secondary end angling rearwardly between said upper side and said lower side.

6. The assembly according to claim 5, wherein:
said secondary end has a blade slot extending into an interior of said second housing, said blade slot extending substantially between said upper side and said lower side of said exterior wall; and
said upper side of said exterior wall has a channel extending inwardly therein, said channel being elongated to extend substantially between said secondary end and said primary end, said channel being positioned closer to said secondary end than said primary end.

7. The assembly according to claim 6, wherein said blade slide includes a button being positioned in said channel in said upper side of said exterior wall of said second housing wherein said button is configured to be manipulated by a user, said blade slide including a frame being slidably positioned within said second housing, said frame being attached to said button such that said frame is slidable toward or away from said secondary end of said second housing when said button is slid toward or away from said secondary end.

8. The assembly according to claim 7, wherein said blade is positionable in said frame of said blade slide, said blade extending outwardly through said blade slot in said secondary end of said second housing when said blade slide is positioned in said extending position having a cutting edge of said blade being directed toward said lower side of said exterior wall of said second housing.

9. A multi-tool assembly including a utility knife and a tape measure, said assembly comprising:
a first housing having a first end, a second end and an outer wall extending therebetween, said outer wall having a top side, a bottom side, a first lateral side and a second lateral side, said first end having a slot extending into an interior of said first housing, said slot being positioned adjacent to said bottom side of said outer wall, said first end having a well extending therein, said well being positioned above said slot, said outer wall having a storage compartment extending into an interior of said first housing for storing a plurality of pencil leads, a respective one of said pencil leads being insertable into said well wherein said respective pencil lead in said well is configured to facilitate a user to make markings, said top side curving upwardly from said bottom side at a point located adjacent to said first end, said top side being curved at an intersection between said top side and said first end;
a cap being removably attachable to said outer wall of said first housing for closing said storage compartment;
a belt clip being coupled to said first housing wherein said belt clip is configured to engage a belt worn by the user, said belt clip being positioned on said outer wall, said belt clip being biased to compress against said outer wall;
a tape measure being integrated into said first housing, said tape measure being drawable outwardly from said first housing wherein said tape measure is configured to facilitate distance to be measured, said tape measure being biased to be retracted into said first housing for storage, said tape measure extending outwardly through said slot when said tape measure is drawn outwardly from said first housing, said tape measure having a distal end being exposed with respect to said first end of said first housing, said distal end having a hook being coupled thereto wherein said hook is configured to engage an edge for securing said tape measure to the edge for measuring distance, said tape measure including a lock being recessed into said first end of said first housing, said lock being positioned between said well in said first end and said top side of said outer wall of said first housing, said lock being movable between a locking position and a releasing position, said lock engaging said tape measure when said lock is positioned in said locking position for retaining said tape measure at a selected length with respect to said first housing, said lock disengaging said tape measure when said lock is positioned in said releasing position thereby facilitating said tape measure to move freely;
a second housing being hingedly coupled to said first housing, said second housing being positionable in a deployed position having each of said first housing and said second housing extending along a common axis, said second housing being positionable in a folded position having said second housing lying against said first housing, said second housing having a primary end, a secondary end and an exterior wall extending therebetween, said exterior wall having an upper side, a lower side and a first lateral side, said primary end being hingedly coupled to said second end of said first housing, said primary end abutting said second end when said second housing is positioned in said deployed position, said first lateral side of said exterior wall resting against said first lateral side of said. outer wall of said first housing when said second housing is positioned in said folded position having said secondary end being positioned adjacent to said first end of said first housing, said secondary end angling rearwardly between said upper side and said lower side, said secondary end having a blade slot extending into an interior of said second housing, said blade slot extending substantially between said upper side and said lower side of said exterior wall, said upper side of said exterior wall having a channel extending inwardly therein, said channel being elongated to extend substantially between said secondary end and said primary end, said channel being positioned closer to said secondary end than said primary end;
a blade slide being slidably integrated into said second housing, said blade slide being urgeable between an extending position and a retracting position, said blade slide including a button being positioned in said channel in said upper side of said exterior wall of said second housing wherein said button is configured to be manipulated by a user, said blade slide including a frame being slidably positioned within said second housing, said frame being attached to said button such that said frame is slidable toward or away from said secondary end of said second housing when said button is slid toward or away from said secondary end; and
a blade being insertable into said blade slide, said blade extending outwardly from said second housing when said blade slide is positioned in said extending position wherein said blade is configured to be employed for cutting, said blade being retracted within said second housing when said blade slide is positioned in said retracting position wherein said blade is configured to be inhibited from cutting, said blade being positionable in said frame of said blade slide, said blade extending outwardly through said blade slot in said secondary end of said second housing when said blade slide is positioned in said extending position having a cutting edge of said blade being directed toward said lower side of said exterior wall of said second housing.
